(19) United States
(12) Patent Application Publication
(10) Pub. No.: US 2010/0196180 A1
(43) Pub. Date: Aug. 5, 2010

(54) VACUUM PUMP

(75) Inventors: Ulrich Jung, Limburg (DE); Christian Harig, Koeln (DE)

Correspondence Address: FAY SHARPE LLP, 1228 Euclid Avenue, 5th Floor, The Halle Building, Cleveland, OH, 44115, US

(73) Assignee: OERLIKON LEYBOLD VACUUM GMBH, KOELN (DE)

(21) Appl. No.: 12/678,294

(22) PCT Filed: Sep. 16, 2008
(86) PCT No.: PCT/EP2008/062304

§ 371 Date: Mar. 16, 2010

(30) Foreign Application Priority Data
Sep. 19, 2007 (DE) 10 2007 044 690.1

(51) Int. Cl. F04D 25/06; F16C 17/20; F04D 19/04

(52) U.S. Cl. 417/423.4; 384/129; 417/423.7

(57) ABSTRACT

A vacuum pump (10) has a pump rotor (16), an active magnetic bearing (20,21), a safety bearing (22,23) associated with the magnetic bearing (20,21), an electric drive motor (18) having a motor stator having a plurality of stator coils (191,192,193) for driving the pump rotor (16), a brake relay (42) having a plurality of changers each having a base contact (62,63,64), a brake contact (44,45,46) and an operational contact (47,48,49), and a short circuit point (60) by way of which all brake contacts (44,45,46) of the brake relay (42) are directly connected to each other. All stator coils (191,192,193) are connected to the base contacts (62,63,64) of the changer, and can be connected directly to each other by way of the brake contacts (44,45,46) of the brake relay (42) and by way of the short circuit point (60), and can be connected to an inverter module (32) by way of the operational contacts (47,48,49).

The invention refers to a fast-running magnetic-bearing vacuum pump with safety earings.

Fast-running vacuum pumps, such as turbomolecular vacuum pumps, for instance, are operated at nominal rotation speeds of several 10,000 to 100,000 rpm. With such vacuum pumps, frictionless magnetic bearings are particularly useful for supporting the pump rotor. In the event of a failure of the magnetic bearing, upon impacts and every time the magnetic bearing cannot or not fully fulfill its function, the pump rotor is supported by one or a plurality of associated mechanical safety bearings that may be configured as roller or sliding bearings. It may take several hours for a vacuum pump to coast down if it has been driven at its nominal rotation speed before. If this happens upon a failure of the magnetic bearing, the safety bearings are stressed considerably so that they will endure only a few so-called full coastings.

In view of this, it is an object of the invention to provide a vacuum pump in which the safety bearings are reliably prevented from damage in the event of a magnetic bearing failure.

According to the invention, this object is achieved with the features of claim 1.

The vacuum pump of the invention comprises a brake relay with a plurality of changers, each changer having a base contact, a brake contact and an operational contact. The changing connection is made between the base contact on the one hand and the brake contact or the operational contact on the other hand. The brake contacts are directly interconnected, thus forming a common short-circuit point. The stator coils of the drive motor are connected to the base contacts of the changer. In the braking position of the changer, the stator coils are directly interconnected electrically via the short-circuit point. In the operating position of the changer, the stator coils are individually connected to an inverter module via the operational contacts. The electric phase pattern required for the operation of the drive motor is generated in the inverter module. During a trouble-free operation, the stator coils are connected to the inverter module via the operational contacts of the changer, the inverter module generating corresponding phase patterns for the respective stator coils. A corresponding changer is provided for each of the stator coils, respectively.

In the event of trouble or of a malfunction, the brake relay is switched to its braking position so that the stator coils are no longer connected to the inverter module but are exclusively connected directly to each other. Due to the simple configuration of the brake relay as a changer and to the simple switching from the operating position to the braking position in case of trouble or malfunction, a reliable switching in the event of troubles is realized in a very simple manner.

After the brake relay has been switched to the braking position, the drive motor operates as a generator. The electric energy generated by the generator in the drive motor stator coils is dissipated or buffered as heat via the housing of the vacuum pump. The entire brake arrangement which is substantially formed by the brake relay and the stator coils, is extremely simple and robust and thus reliable. In the event of a malfunction, the immediate switching of the changer to the braking position and the immediate onset of the braking effect allow to achieve a fast and efficient reduction of the rotational speed.

Especially in the event of the inverter module itself being defective and the reason for a risk of destruction, the immediate separation of the inverter module from the stator coils prevents any detrimental effect of the inverter module after such a malfunction has been detected.

Preferably, the motor stator which is substantially formed by the stator coils and a stator lamination, is connected to a heat absorbing body without an air gap therebetween. For instance, the motor stator may be pressed into a correspondingly shaped heat absorbing body so that the interfaces make large-surface contact and provide good thermal conduction. Possibly, the heat absorbing body may be connected to the motor stator in good thermal conduction using auxiliary means, such as thermally conductive paste, thermally conducive films and the like. By providing a heat absorbing body, the heat produced in the stator coils in the event of braking can be dissipated reliably and effectively from the motor stator to be stored with a large thermal capacity or to be dissipated into the ambient atmosphere.

In a preferred embodiment, a mean thermal resistance of less than 0.1 K/W prevails between the motor stator and the heat absorbing body. In this manner a reliable dissipation of the braking heat is guaranteed and overheating of the stator coils is avoided even with high braking efforts and rather small interfaces between the motor stator and the heat absorbing body.

In a preferred embodiment, a temperature sensor is associated with the motor stator and/or the heat absorbing body, a power switch influencing the electric braking effort as a function of the temperature measured by the temperature sensor. Thereby, overheating of the stator coils is prevented in an absolutely reliable manner. The power switch may be of a single-stage or a continuous design.

In a preferred embodiment, the heat absorbing body is formed by the pump housing. Thus, the motor stator is connected to the pump housing, either directly or indirectly, but in any case in good thermal conduction. Preferably, the pump housing is made of aluminum since aluminum has good thermal conduction and thermal capacity properties.

As an alternative or in addition, the heat absorbing body may also be formed by a separate heat absorbing element made from another material than the pump housing and the motor stator or the stator lamination. For instance, the heat absorbing element can be made from a material that has a phase transition between 30° C. and 80° C. Since a phase transition always comes with a high consumption of thermal energy, a heat absorbing element of such design can absorb a lot of energy without heating up significantly. A suitable material is a low-temperature metal, wax, water and the like, for instance. Whereas a material that has a phase transition between a solid and a liquid in the temperature range mentioned shows a reversible behavior, the use of water as the material of the heat absorbing element is restricted to an irreversible phase transition. After a braking, the water would have to be filled up again.

Preferably, the brake contact is a normally closed contact and the operational contact is a normally open contact of the brake relay. Generally, the brake contact may also be configured as a normally open contact and the normally closed contact may be configured as the operational contact. However, in case of a breakdown of the energy supply for the operation of the brake relay, such an arrangement would have the effect that the brake relay could no longer be switched into the braking state or braking position. Therefore, it is advantageous to use the normally closed contacts of the brake relay for the interconnection of the motor coils.

Preferably, the safety bearing is designed as a sliding bearing. Preferably, the brake relay is a mechanical relay. In contrast with an electronic relay, only a mechanical relay offers the possibility of a true galvanic separation of the stator coils of the drive motor from the remaining control and regulation of the vacuum pump. In the event of a complete breakdown of the energy supply, the mechanical relay automatically assumes its rest position which preferably is the failure position or the braking position so that a high degree of security with respect to a fusing and an undesired short-circuiting of the changer contacts are achieved.

In a preferred embodiment, a relay control is provided for controlling the brake relay, which control has a failure report input connected to an electric module, the relay control switching the brake relay into a failure state if a failure report signal from at least one electric module is applied to a failure report input. An electric module in the present sense may be the inverter module, a computing module, a watchdog module monitoring the operation of the computing module, a power supply module and/or a magnetic bearing control module. Each of the modules mentioned is preferably connected to a distinct failure report input of the relay control via a distinct signal line.

The relay control is a module in itself which controls the brake relay. The relay control has a plurality of failure report inputs that are each connected to a respective electric module of the vacuum pump, that are directly or indirectly involved in the operation of the pump rotor, and that are involved in the operation of the magnetic bearing and the drive motor in particular. If only a single module of the modules thus connected to a failure report input of the relay control issues a failure report to the relay control, the brake relay is switched into the failure state.

Especially in the event that the inverter module itself is defective and is the cause of potential destruction, the immediate separation of the inverter module from the motor coils prevents further detrimental effects of the inverter module after the detection of such a failure.

The failure or braking state is not initiated immediately by the inverter module. The selection of the inverter module does not affect the functionality of the brake relay or the relay control.

The brake relay is in its operational state or in its operational position, in which the motor coils are connected to the inverter module, if
the electric voltage supply does not provide too low or too high a voltage,
the computing module has not detected a failure in any one of the other modules,
the watchdog module, which in turn monitors the correct function of the computing module, has not detected a malfunction, and
no important electric line between a pump unit and the control unit is interrupted.

Of course, further modules and components of the vacuum pump may be connected to a failure report input of the relay control.

Preferably, the safety bearings are designed as sliding bearings. Sliding bearings are generally more economic than roller bearings. The reliable braking of the pump rotor in the event of a failure or braking considerably reduces the wear of the sliding bearing. Thus, a rather low-cost sliding bearing can be used as a safety bearing even with high nominal rotation speeds and great pump rotor masses.

In a preferred embodiment of the invention, the vacuum pump is a turbomolecular vacuum pump. Turbomolecular vacuum pumps are typically operated at very high rotational speeds of several 10,000 rpm, which is why they are particularly suitable for the use of a magnetic bearing with a respective safety bearing associated therewith.

The following is a detailed description of two embodiments of the invention with reference to the drawing.

In the Figures:

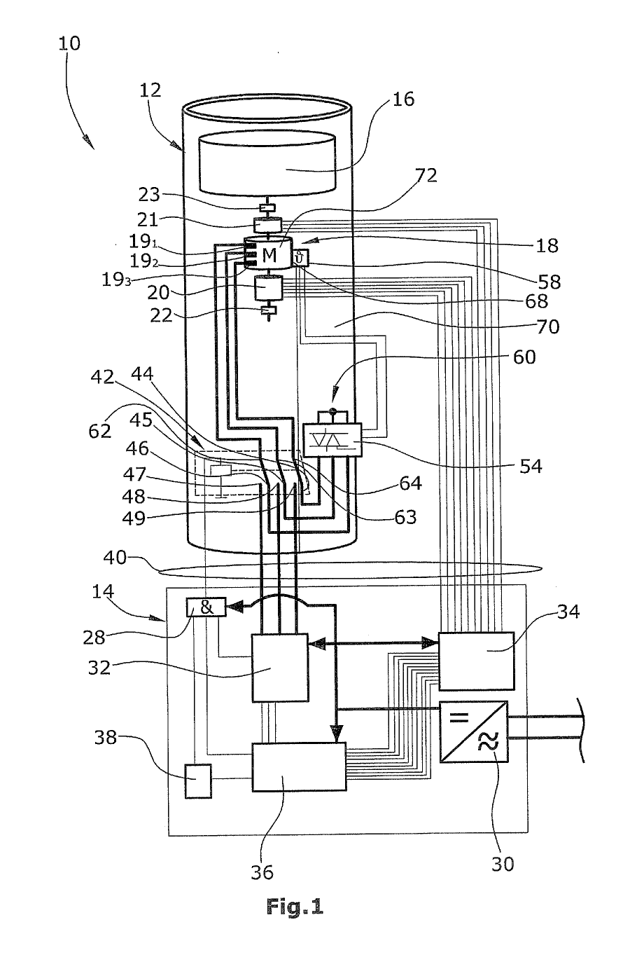

FIG. 1 schematically illustrates a vacuum pump with a brake relay which, in the event of a failure or braking, short-circuits the stator coils of the drive motor, the heat absorbing body being formed by the pump housing,

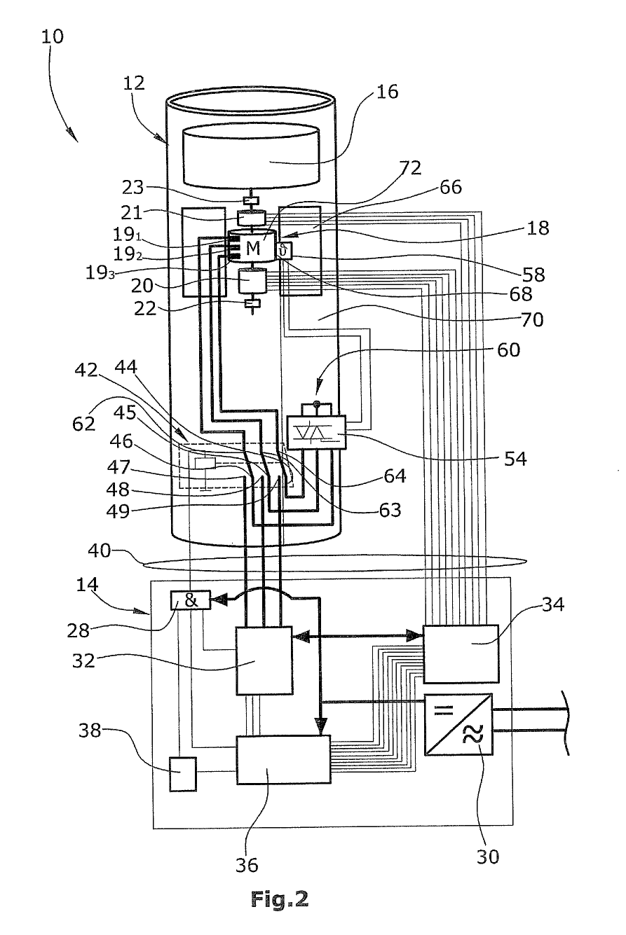

FIG. 2 illustrates a vacuum pump as in FIG. 1, differing in that the heat absorbing body is formed by a separate heat absorbing element.

FIGS. 1 and 2 illustrate a turbomolecular vacuum pump 10 formed by a pump unit 12 and a control unit 14 that are interconnected via electric connection lines 40.

In its pump unit 12, the vacuum pump 10 comprises a pump rotor 16 driven by an electric drive motor 18 with a nominal rotation speed of up to 100,000 rpm. The rotor shaft is magnetically supported in two magnetic bearings 20, 21 which are each multiaxial and together form a five-axis magnetic bearing. The magnetic bearings 20, 21 are associated with safety bearings 22, 23 designed as mechanical sliding bearings or roller bearings.

The drive motor 18 is a three-phase DC brushless motor and has three stator coils 19₁, 19₂, 19₃. However, the drive motor may also be an asynchronous machine or a reluctance motor.

The pump unit 12 further comprises a brake relay 42 having three changers. A changer includes three base contacts 62, 63, 64, three operational contacts 47, 48, 49 configured as normally open contacts, as well as three brake contacts 44, 45, 46 configured as normally closed contacts. The three stator coils 19₁, 19₂, 19₃ are each connected to a respective base contact 62, 63, 64. The brake contacts 44, 45, 46 are each directly interconnected via a power switch 54. The connection of the three brake contacts 44, 45, 46 behind the power switch 54 forms a short-circuit point 60.

The power switch 54 is coupled with a temperature sensor 58 that is fastened to the motor stator 72 in a heat conducting manner. When an overheating of the stator coils 19₁, 19₂, 19₃ is imminent in a braking event, the power switch 54 is opened and will only be closed when the temperature of the motor stator 72 detected by the temperature sensor 58 has fallen to an allowable temperature again. The power switch 54 may also be designed for a continuously variable control of the braking effort.

The vacuum pump 10 of FIG. 1 is immediately connected in a heat conducting manner to the aluminum pump housing 70 through its motor stator 72. A thermally conductive layer 68 in the form of a thermally conductive paste or a thermally conductive film is provided between the motor stator 72 and the pump housing 70. The thermally conductive layer 68 makes a good thermally conductive connection between the motor stator 72 and the housing 70 so that in this region a low thermal resistance is obtained. The stator coils 19₁, 19₂, 19₃ are connected in a good thermally conductive manner to the stator lamination of the motor stator, for instance by casting in a good thermally conductive casting mass and/or by using a form-fit coil support. Since a part of the braking energy is dissipated in the stator coils 19₁, 19₂, 19₃, a low thermal resistance guarantees for a good thermal conduction from the stator coils 19₁, 19₂, 19₃ to the heat absorbing body 70. In the embodiment of FIG. 1, the housing 70 forms a heat absorbing body 70.

In the embodiment of FIG. 2, the heat absorbing body is formed by a separate heat absorbing element 66 that surrounds the motor stator 72 and is coupled therewith in a good thermally conductive manner. The heat absorbing element is formed from a material that changes its aggregate state in a range between 30° C. and 80° C., for instance wax. Other materials suitable as the material of the heat absorber element may be a low-temperature metal, such as lead or similar materials. Water may also serve as the material of the heat absorber element, however, the phase transition thereof from a liquid state to a gaseous state would be irreversible.

The control unit 14 comprises a power supply module 30 for supplying voltage to all other modules and components, an inverter module 32 for energizing the motor coils 19₁, 19₂, 19₃, a magnetic bearing control module 34 for controlling the magnetic bearings 20, 21, a computing module 36 for controlling and monitoring in particular the magnetic bearing control module 34 and the inverter module 32, a watchdog module 38 for monitoring the functionality of the computing module 36, as well as a relay control 28 for controlling the base relay 42.

The relay control 28 comprises a plurality of failure report inputs connected to the inverter module 32, the computing module 36 and the watchdog module 38 via corresponding electric signal lines. If only one of the three above-mentioned modules 32, 36, 38 sends a failure signal to the corresponding failure report input of the relay control 28, the relay control 28 switches the brake relay 42 into the failure or braking state illustrated in the Figures. The brake relay 42 is a purely mechanical relay.

The magnetic bearing control module 34 and the power supply module 30 may optionally also be connected to a failure report input of the relay control module 28 via a corresponding signal line.

The pump rotor 16 may alternatively only be actively supported magnetically by one, two, three or four axes, while the other axes are passively or mechanically supported.

The watchdog module 38 is notified by the computing module 30 in regular intervals of typically a few microseconds to milliseconds. When the agreed notification signal fails to arrive, the watchdog module 38 issues a failure signal to the relay control 28.

Likewise, the inverter module 32 and/or the computing module 36 can issue a failure signal directly to the relay control 28, if the above modules 32, 36 internally or externally detect irregularities that justify an immediate braking of the vacuum pump or of the pump rotor 16.

The computing module 36 also monitors the functionality of the magnetic bearing control module 34 and of the power supply module 30.

In the event of an interruption of the electric connection lines 40 between the pump unit 12 and the control unit 14, the brake relay 42 automatically assumes the brake state or the braking position so that in this case, too, the motor coils 19₁, 19₂, 19₃ are short-circuited.

1. A vacuum pump comprising
a pump rotor,
an active magnetic bearing,
a safety bearing associated with the magnetic bearing,
an electric drive motor with a motor stator having a plurality of stator coils for driving the pump rotor,
a brake relay having a plurality of changers, each respectively comprising a base contact, a brake contact and an operational contact, and
a short-circuit point via which all brake contacts of the brake relay are directly interconnected,
all stator coils being connected to the base contacts of the changers and being directly interconnectable via the brake contacts of the brake relay and via the short-circuit point and being connectable to an inverter module via the operational contacts.

2. The vacuum pump of claim 1, wherein the motor stator which comprises the stator coils and a stator lamination, is connected to a heat absorbing body without an air gap therebetween.

3. The vacuum pump of claim 1, wherein the thermal connection between the motor stator and the heat absorbing body has a mean heat resistance of less than 0.1 K/W.

4. The vacuum pump of claim 1, wherein a temperature sensor is associated with the motor stator and/or the heat absorbing body, a power switch influences the electric braking effort as a function of the temperature measured by the temperature sensor.

5. The vacuum pump of claim 1, wherein the heat absorbing body is formed by the pump housing.

6. The vacuum pump of claim 5, wherein the pump housing is made of aluminum.

7. The vacuum pump of claim 1, wherein the heat absorbing body is formed by a separate heat absorbing body that is formed from another material than the pump housing.

8. The vacuum pump of claim 7, wherein the heat absorbing element is formed from a material having a phase transition between 30° C. and 80° C.

9. The vacuum pump of claim 1, wherein the brake contact is a normally closed contact and the operational contact is a normally open contact.

10. The vacuum pump of claim 1, wherein the brake relay is a mechanical relay.

11. The vacuum pump of claim 1, wherein the safety bearings are configured as sliding bearings.

12. The vacuum pump of claim 1, wherein the vacuum pump is a turbomolecular vacuum pump.

13. The vacuum pump of claim 1, wherein a relay control is provided which has a failure report input connected to an electric module, the relay control switching the brake relay into a braking state closing the brake contact, if a failure signal from at least one of the electric modules is present at the failure report input.

14. The vacuum pump of claim 13, wherein the electric module is an inverter module, a computing module, a watchdog module monitoring the operation of the computing module, a power supply module and/or a magnetic bearing control module, each module being connected to a failure report input of the control relay via a distinct signal line.

15. A vacuum pump comprising:
a pump rotor;
an active magnetic bearing which rotatably supports the pump rotor in a pump housing;
a plurality of stator coils electromagnetically coupled to the rotor;
a switching system which (1) interconnects the stator coils into a regenerative braking system to stop the rotor and (2) disconnects the stator coils from the regenerative braking system and supplies the electrical power to the stator coils to rotate the rotor in a pumping mode.
